(19) United States
(12) Patent Application Publication
(10) Pub. No.: US 2014/0272380 A1
(43) Pub. Date: Sep. 18, 2014

(54) CO-EXTRUDED PLASTIC FILM WITH A FOAM CORE AND A METHOD FOR COATING THE FILM ON A SUBSTRATE

(71) Applicant: Graham Chapman, Niagara-on-the-Lake (CA)

(72) Inventor: Graham Chapman, Niagara-on-the-Lake (CA)

(73) Assignee: Petoskey Plastics, Inc., Petoskey, MI (US)

(21) Appl. No.: 13/839,019

(22) Filed: Mar. 15, 2013

(51) Int. Cl. B32B 5/18; B29C 44/24

(52) U.S. Cl. CPC B32B 5/18; B29C 44/24
USPC 428/317.7; 428/318.6; 264/45.3; 264/447

(57) ABSTRACT

A co-extruded plastic film structure that has increased rigidity. The film is extruded on a three layer extrusion line with the core layer based on a foamed polymer. The outer layers comprise a polyolefin combined with non-plastic particulate. The film may be coated onto a substrate, such as paper.

### FIELD OF THE INVENTION

The present invention is directed to the field of polymer films. More specifically, the present invention is directed to multiple layer extruded polymer films that exhibit dead fold or creasing properties, as well as a method of coating of these films on a substrate.

### BACKGROUND INFORMATION

Plastic films can be produced cheaply, but they tend to have some disadvantages. Although plastic films can be easily bent and shaped around an object, they have a tendency to spring back or recover to an unfolded state. Aluminum foil, on the other hand, possesses very good dead fold and shaping characteristics. That is, once the foil is wrapped about an object, the foil maintains its shape and does not unfold as plastic films tend to do. However, aluminum foil is expensive, relative to plastic film, and there is no way to make the foil transparent (or even translucent) like plastic films can be.

“Dead fold” is the property of a sheet of material to maintain a desired angle of a fold and not to “spring back” or otherwise unfold. A sheet that has good dead fold will plastically deform along a fold line and then hold the fold. Many types of paper have dead fold, as do many types of metal when formed into sheets. In contrast, textiles generally do not have dead fold because, although they are easily folded, they do not have enough rigidity to retain the fold. Plastic sheets may or may not have dead fold properties, depending upon stiffness of the plastic. When it is desired to increase the stiffness of a film (or sheet) of commodity polymer, the conventional approach is to increase the thickness of the film (or sheet). A disadvantage of the conventional approach is that it increases the amount of material, which increases weight and cost.

One proposal to increase the stiffness of a plastic sheet is to foam the material and extrude it. Foam plastic sheeting has been made before, for example as shown in U.S. Pat. No. 3,637,458 to Parrish. The foaming can be accomplished by either by using a foaming agent, which can be included in the melt, or by direct injection of a gas in the extruder. Difficulties with foaming a single extruded layer arise because of gas escape (i.e., rupture of bubbles at the surface) and roughness of the film's resulting surface.

Lamination of films has also been practiced. Extrusion of a multi-layer structure with a foam is described in U.S. Pat. No. 4,657,811 to Boyd et al., in which the outer “skin” layers are between 0.25 and 0.50 mils thick, and azodicarbonamide is used as the blowing agent. Such laminated arrangements have been made for the purpose of providing insulation or cushioning and may provide some stiffening of the resulting products. However, the laminated foam products of the prior art are springy and resilient, with a substantial resistance to taking and holding a fold.

What is needed is a way to make a plastic film stiffer and to have a dead fold property, while minimizing the amount of material used.

### SUMMARY OF THE INVENTION

One aspect of the present invention is to provide stiffening of a plastic film or sheet at minimum cost.

Another aspect of the present invention is to provide a plastic film or sheet that has dead fold.

Yet another aspect of the present invention is to coat a plastic film according to the invention onto a substrate, such as paper, without losing the stiffening effect of the foamed multi-layer structure.

A sheet or film according to embodiments of the present invention has two outer film layers with a foamed core layer laminated in between. By co-extruding three layers with the core being foamed increases stiffness while overcoming the disadvantages of excessive material usage, gas escape, and a rough surface. To avoid the problem of foam core sheets not having dead fold (i.e., being unable to take and hold a fold) the present invention encompasses a way to extrude and laminate the films that differs from conventional extrusion processes used for blowing or casting film.

According to at least some embodiments of the present invention, the stiffness characteristics of the multilayer sheet are enhanced by the inclusion of non-plastic particles in the non-foamed layers.

According to a first embodiment of the present invention, an article of manufacture, a multilayer plastic sheet has a top layer, a foam core layer, and a bottom layer. Both the top layer and the bottom layer are plastic and each contains at least 10% by weight of non-plastic particulate. The foam core layer is co-extruded with and disposed between the top and bottom layers to form a unitary plastic sheet having dead fold.

According to a second embodiment of the present invention, a process for manufacturing a multilayer plastic sheet having dead fold, the process includes preparing two plastic extrudates, each having a polyolefin and a non-plastic particulate. A third plastic extrudate is prepared having a polyolefin and a chemical blowing agent. All three extrudates are then extruded together so that the first two form a top layer and a bottom layer, respectively, and the third forms a plastic foam core layer disposed between the top and bottom layers to form a unitary plastic sheet.

According to a third embodiment of the present invention, an article of manufacture, a composite sheet includes a paper sheet, a plastic adhering layer coated onto the paper sheet at a high melt temperature, a plastic foam core layer, and a plastic top layer. The adhering layer and the top layer each contain at least 10% by weight of non-plastic particulate. The foam core layer is co-extruded with and disposed between the top and bottom layers to form a unitary plastic sheet having dead fold and that is adhered to the paper sheet.

According to a fourth embodiment of the present invention, a process for manufacturing a composite sheet having dead fold, the process includes preparing a first plastic mixture with polyethylene and a first non-plastic particulate, preparing a second plastic mixture with a polyolefin and a second non-plastic particulate, and preparing a third plastic mixture with a polyolefin and a chemical blowing agent. A sheet of paper is corona treated and is then coated using the first plastic mixture at a high coating melt temperature to form a coated paper sheet. The coated paper sheet is corona treated and then coated by co-extrusion of the second plastic mixture and the third plastic mixture together so that the first plastic mixture forms the adhering layer, the second plastic mixture forms a plastic top layer, and the third plastic mixture forms a plastic foam core layer extruded with and disposed between the top and adhering layers to form a unitary plastic film adhered to the paper sheet.

### DETAILED DESCRIPTION

The yield point may be defined as that point at which the application of strain increases without the application of further tensile stress. Some ductile polymers typically exhibit both an upper and a lower yield point.

When an applied tensile stress reaches the yield point of the polymer, the elastic limit is exceeded and a permanent set or deformation takes place (i.e., a fold or crease). Thus, once the film of the present invention is folded to a sharp radius, the tensile strain developed at the radius is above the yield point, and permanent deformation occurs. Once the elastic limit is passed, there is a greatly reduced tendency for the film to spring back to its original shape.

Suitable generally ductile polymeric materials for use in the outer layers of the present invention include all types of polyolefins. Low density polyethylene (LDPE), linear low density polyethylene (LLDPE), and high density polyethylene (HDPE) are examples of polyolefins suitable for an outer layer. Regarding the core layer, many polyolefins are suitable. However, because of its intrinsic comparative stiffness, homopolymer polypropylene (PP) is a preferred choice for the foamed core layer. For some specific applications copolymers of polyolefins, such as ethylene vinyl acetate (EVA), ethylene acrylic acid (EAA) and other acid copolymers can be used.

The film of the present invention is preferably formed by coextrusion of the layers of polymeric materials. The terms “coextrusion” and “extruded sheet” are used in the context of this disclosure to refer to two or more thermoplastic polymeric materials which are brought together from three or more extrusion means and placed in contact with one another prior to their exit through an extrusion die to form the extruded film.

According to an alternate embodiment, the film of the present invention may also be formed as a laminate. The term “laminate” refers to three or more layers of thermoplastic polymeric materials that are brought together under conditions of high pressure and/or temperature, and/or in the presence of adhesives in order to adhere the layers to one another.

The thickness of the film may vary depending upon the particular application desired. For typical applications, the film may be embodied having a thickness of from about 1.5 mil to about 3.5 mil. The number of layers in the film can also vary since the invention is not limited to being embodied with only three layers.

Embodiments of the present invention include a powdered filler material in the outer layers of the film. Filler materials useful for the present invention include talc, silica, precipitated silica, titanium dioxide, clay, nanoclay, sodium aluminum silicate, calcium carbonate or mixtures thereof.

To combine a foam core film according to the present invention with a substrate, an attempt was made to coat this stand-alone three-layer film onto paper. However, to achieve sufficient adhesion a high melt temperature (>450° F.) is required and this was discovered to be unworkable with the foamed film and even flame treating of the paper did not allow the coating to adhere sufficiently. Additionally, there was a problem when the compression of the rolls after extrusion was applied to the composite structure (foam core film+paper), as the bubbles in the foam tended to collapse.

To overcome this problem applicant discovered a two-stage process in which the paper is corona treated and is first coated with a strongly adhering thin polyethylene-based layer in a conventional way utilizing a coating melt temperature of 579-581° F. The adherence layer utilizes a mixture of both HDPE and LDPE. The paper is then corona-treated again and the foamed polymer layer was coated onto the adherence layer.

The following examples are described to help make the invention readily understandable. These examples are intended to illustrate the invention, and are not to be taken as limiting the scope of the invention.

### Example 1

In this first example, a three layer stiff foamed film is formed having a formulation according to the parameters set forth in TABLE 1.

TABLE 1

| Layer | Thickness (mil) by weight | Composition |
|---|---|---|
| top | 1.0 | 40% talc masterbatch |
| | | 60% MMW HDPE |
| core | 1.0 | 1.2% blowing agent masterbatch |
| | | 98.8% polypropylene |
| | | homopolymer |
| bottom | 0.5 | 40% talc masterbatch |
| | | 60% MMW HDPE |

The talc masterbatch selected to produce the filler in the outer layers of the first example film is a 60% talc concentrate that is commercially available from Bayshore Plastics. The MMW HDPE (medium molecular weight high density polyethylene) used for both outer layers is commercially available from ExxonMobil, and is spec'd as HDZ 222, MI 2.4, density 0.964. The polypropylene used for the core layer is also an ExxonMobil product, spec'd as PP 4062 E7, homopolymer, MI 3.7, density 0.90. The blowing agent used in this example is sourced from Ampacet Corporation (Tarrytown, N.Y.) as their product code 703061-H.

This formulation was run on a 12″ three layer Killion cast film line. The extrusion was run under conditions set forth in TABLE 2.

TABLE 2

| | 1″ 30L/D | 1.5″ 24L/D | 1.25″ 24L/D |
|---|---|---|---|
| Extruder Position | top (chill roll) | core | bottom (air knife) |
| Rotation speed | 31 | 34 | 36 |
| (rpm) | | | |
| Pressure (psi) | 2,330 | 2,220 | 2,100 |
| Melt temperature | 400 | 417 | 416 |
| (° F.) | | | |
| Barrel 1 (° F.) | 360 | 359 | 350 |
| Barrel 2 (° F.) | 454 | 412 | 450 |
| Barrel 3 (° F.) | 420 | 410 | 420 |
| Barrel 4 (° F.) | 420 | | |
| Adapter (° F.) | 410 | 410 | |
| Die, 1, 2 and 3 (° F.) | | 410 | |

The thickness of the resulting extruded film, measured by micrometer, ranged from 3.2 to 3.5 mil (compare foamed thickness to the weight thickness of 2.5). The resulting extruded film also has dead-fold capability. The 1% secant modulus for the foamed film was 169,363 psi in the machine direction and 158,871 psi in the transverse direction. For comparison, the corresponding non-foamed film has a 1% secant modulus of 68,100 psi in the machine direction and 34,284 psi in the transverse direction.

### Example 2

In this second example, a three-layer stiff foamed film is combined with a paper substrate. Using applicant's discovered paper-and-foamed-film compositing process, as described above, in a first stage the paper is corona treated and coated with a strongly adhering thin polyethylene-based layer in a conventional way utilizing a coating melt temperature of 579-581° F. In order to obtain the desired stiffness the coating formulation used for the adherence layer in this example is 40% HDPE:30% LDPE:30% talc masterbatch. The thickness of the coating is approximately 0.25 mil (6 microns).

The coated paper is then corona treated again and is coated with the foamed structure according to the parameters as set forth in TABLE 3.

TABLE 3

| Layer | Thickness (mil) by weight | Composition |
|---|---|---|
| top | 0.5 | 40% HDPE |
| | | 30% LDPE |
| | | 30% talc masterbatch |
| core | 0.5 | 1% blowing agent masterbatch |
| | | 99% polypropylene |
| bottom | 0.25 | 40% HDPE |
| | | 30% LDPE |
| | | 30% talc masterbatch |

The talc masterbatch selected to produce the filler in the top and bottom layers of the second example film is a 60% talc concentrate that is commercially available from Bayshore Plastics. The plastics are all commercially sourced from Equistar Chemical Co.: The polypropylene is Equistar PP31KK01X homopolymer; the HDPE is Equistar M6060, MI 6.0, density 0.960, and the LDPE is Equistar NA 219, MI 10, density 0.923. The blowing agent is Ampacet masterbatch 703061-H.

The formulation is run on a three-layer film coating line with a Cloeren die 22″ wide. The selected paper is 30# bleached Kraft paper. The extrusion is run under conditions set forth in TABLE 4.

TABLE 4

| | 2.5″ 28:1 L/D | 2″ 28:1 L/D | 2″ 28:1 L/D |
|---|---|---|---|
| Extruder Position | top (air side) | core | bottom (coating side) |
| Rotation speed | 15.1 | 10.9 | 44.1 |
| (rpm) | | | |
| Pressure (psi) | 2,700 | 1,230 | 2,930 |
| Melt temperature | 402 | 420 | 427 |
| (° F.) | | | |
| Barrel 1 (° F.) | 360 | 381 | 370 |
| Barrel 2 (° F.) | 370 | 391 | 380 |
| Barrel 3 (° F.) | 380 | 400 | 390 |
| Barrel 4 (° F.) | 380 | 400 | 400 |
| Barrel 5 (° F.) | 380 | | |
| Adapter/flange | 380 | 400 | 410 |
| (° F.) | | | |
| Die (° F.) | | 410 | |

The composite of paper coated with the foam core plastic film has stiffness greater than the stand-alone film of the first example and the coated paper has excellent dead-fold characteristic. Another advantage from adding a paper layer to the plastic film is that the paper layer can absorb water and oil. This is useful for certain applications such as a protective floor mat.

Plastic films and plastic/paper composite films embodied according to the present invention are useful as replacements for paper while avoiding some of the major disadvantages of paper, such as its poor wet strength and high vapor permeability. Non-paper sheets with the dead fold property provided by the present invention are useful for making envelopes, for use as drop cloths, as a packaging material, for use as a wrapping material, and as twist ties to bind bundles or bags. These examples, which are discussed in more detail below, are not intended to be limiting and are meant to serve as illustrative cases for how sheets embodied according to the present invention may applied.

Mailing envelopes formed using films described in this disclosure will mimic many properties of paper (e.g., dead-fold) while retaining its strength properties when exposed to water. Such envelopes would also provide some degree of protection for their contents from exposure to liquid water, not unlike the sheets of nonwoven spunlaid high-density polyethylene fibers sold under the name Tyvek™. Unlike Tyvek™ the present invention would also resist intrusion of water vapor and it does a better job of mimicking how paper can take a fold.

Another paper-replacement application is for painter's drop cloths, providing handling characteristics that mimic paper, without the susceptibility to bleed-through of spilled paint that paper has. Packaging of all kinds, from retail bags and wrappers to corrugated shipping boxes, are excellent applications that are suited to the combination of advantages the present invention provides. Sheets of material according to the present invention may be used as wrapping material because it will fold like paper and cut like paper, but unlike paper will resist moisture damage.

Twist-ties are another application for this invention. Because strips of sheeting according to embodiments of the present invention have dead fold, they will take and hold a twist, which can be thought of as a helical fold.

While certain representative embodiments and details have been shown for purposes of illustrating the invention, it will be apparent to those skilled in the art that various changes in the methods and apparatus disclosed herein may be made without departing from the scope of the invention.

What is claimed is:

1. A plastic sheet comprising:
a plastic top layer containing at least 10% by weight of a first non-plastic particulate;
a plastic bottom layer containing at least 10% by weight of a second non-plastic particulate; and
a plastic foam core layer co-extruded with and disposed between the top and bottom layers to form a unitary plastic sheet having dead fold.

2. The plastic sheet according to claim 1, wherein the top layer, the bottom layer and the foam core layer each comprise a polyolefin material.

3. The plastic sheet according to claim 2, wherein the polyolefin material for each of the top and bottom layers comprises polyethylene.

4. The plastic sheet according to claim 2, wherein the polyolefin material for the core layer comprises polypropylene.

5. The plastic sheet according to claim 1, wherein the core layer is foamed using a chemical blowing agent.

6. The plastic sheet according to claim 1, wherein the first and second non-plastic particulates are each selected from the group consisting of: talc, silica, precipitated silica, titanium dioxide, clay, nanoclay, sodium aluminum silicate, calcium carbonate or mixtures thereof.

7. A composite sheet comprising:
a paper sheet;
a plastic adhering layer containing at least 10% by weight of a first non-plastic particulate, the adhering layer being coated onto the paper sheet at a high melt temperature;
a plastic top layer containing at least 10% by weight of a second non-plastic particulate; and
a plastic foam core layer extruded with and disposed between the adhering and top layers to form a unitary plastic film having dead fold and adhered to the paper sheet.

8. The composite sheet according to claim 7, wherein the top layer and the adhesion layer each comprise at least 20% high density polyethylene and at least 20% low density polyethylene.

9. The composite sheet according to claim 7, wherein the foam core layer comprises polypropylene.

10. The composite sheet according to claim 7, wherein the first and second non-plastic particulates are each selected from the group consisting of: talc, silica, precipitated silica, titanium dioxide, clay, nanoclay, sodium aluminum silicate, calcium carbonate or mixtures thereof.

11. A process for manufacturing a plastic sheet having dead fold, the process comprising:
preparing a first plastic extrudate comprising a polyolefin and at least 10% by weight of a first non-plastic particulate;
preparing a second plastic extrudate comprising a polyolefin and at least 10% by weight of a second non-plastic particulate;
preparing a third plastic extrudate comprising a polyolefin and a chemical blowing agent;
co-extruding the first, second, and third plastic extrudates together so that the first plastic extrudate forms a plastic top layer, the second plastic extrudate forms a plastic bottom layer, and the third plastic extrudate forms a plastic foam core layer disposed between the top and bottom layers to form a unitary plastic sheet.

12. The process for manufacturing a plastic sheet having dead fold according to claim 11, wherein the polyolefin material for each of the top and bottom layers comprises polyethylene.

13. The process for manufacturing a plastic sheet having dead fold according to claim 11, wherein the polyolefin material for the core layer comprises polypropylene.

14. The process for manufacturing a plastic sheet having dead fold according to claim 11, wherein the first and second non-plastic particulates are each selected from the group consisting of: talc, silica, precipitated silica, titanium dioxide, clay, nanoclay, sodium aluminum silicate, calcium carbonate or mixtures thereof.

15. A process for manufacturing a composite sheet having dead fold, the process comprising:
preparing a first plastic mixture comprising polyethylene and at least 10% by weight of a first non-plastic particulate;
preparing a second plastic mixture comprising a polyolefin and at least 10% by weight of a second non-plastic particulate;
preparing a third plastic mixture comprising a polyolefin and a chemical blowing agent;
corona treating a paper sheet;
coating the paper sheet with an adhering layer using the first plastic mixture at a coating melt temperature of over 570° F. as to form a coated paper sheet;
corona treating the coated paper sheet;
co-extruding the second plastic mixture and the third plastic mixture together, along with the coated paper sheet, so that the first plastic mixture forms the adhering layer, the second plastic mixture forms a plastic top layer, and the third plastic mixture forms a plastic foam core layer extruded with and disposed between the top and adhering layers to form a unitary plastic film adhered to the paper sheet.

16. The process for manufacturing a composite sheet having dead fold according to claim 15, wherein the first plastic mixture comprises low density polyethylene and high density polyethylene.

17. The process for manufacturing a composite sheet having dead fold according to claim 15, wherein the polyolefin of the second plastic mixture comprises low density polyethylene and high density polyethylene.

18. The process for manufacturing a composite sheet having dead fold according to claim 15, wherein the polyolefin of the third plastic mixture comprises polypropylene.

19. The process for manufacturing a composite sheet having dead fold according to claim 15, wherein the first and second non-plastic particulates are each selected from the group consisting of: talc, silica, precipitated silica, titanium dioxide, clay, nanoclay, sodium aluminum silicate, calcium carbonate or mixtures thereof.
